(19) United States
(12) Patent Application Publication
(10) Pub. No.: US 2021/0360867 A1
(43) Pub. Date: Nov. 25, 2021

(54) Led grow-light system

(71) Applicant: DemeGrow, Inc., Sacramento, CA (US)

(72) Inventor: Blane J. Goettle, Golden River, CA (US)

(73) Assignee: DemeGrow, Inc., Sacramento, CA (US)

(21) Appl. No.: 17/300,272

(22) Filed: May 5, 2021

Related U.S. Application Data
(60) Provisional application No. 63/101,561, filed on May 5, 2020.

(51) Int. Cl. A01G 7/04; F21S 4/28; F21S 8/06

(52) U.S. Cl. CPC A01G 7/045; F21Y 2115/10; F21S 8/06; F21S 4/28

(57) ABSTRACT

The LED Grow-light System has grow-light canopies housed within modular grow containers. The modular grow containers include sky-light structure including light panels and light tubes that allow the modular grow containers to be stacked or placed next to each other to minimize the footprint for growing plants.

### RELATED APPLICATION

This application claims priority under 35 U.S.C. § 119(e) from the co-pending U.S. provisional patent application Ser. No. 63/101,561, filed on May 5, 2020, and titled “LED GROW-LIGHT SYSTEM.” The co-pending U.S. provisional patent application Ser. No. 63/101,561, filed on May 5, 2020, and titled “LED GROW-LIGHT SYSTEM” is hereby incorporated by reference.

### FIELD OF THE INVENTION

The invention relates to LED lighting systems. More particularly, the present invention relates to LED grow-light systems with uniform light distribution.

### BACKGROUND OF THE INVENTION

A grow-light is an artificial light source, generally an electric light, designed to simulate plant growth by emitting a light appropriate for photosynthesis. Grow-lights are used for horticulture, indoor gardening, plant propagation and food production, including indoor hydroponics and aquatic plants. Although most grow-lights are used on an industrial level, they can also be used in households. Grow-lights either attempt to provide a light spectrum similar to that of the sun, or to provide a spectrum that is more tailored to the needs of the plants being cultivated. Depending on the type of plant being cultivated, the stage of cultivation (e.g. the germination/vegetative phase or the flowering/fruiting phase), and the photo-period required by the plants, specific ranges of spectrum, luminous efficacy and color temperature are desirable for use with specific plants and time periods.

According to the inverse-square law, the intensity of light radiating from a point source (in this case a bulb) that reaches a surface is inversely proportional to the square of the surface's distance from the source (if an object is twice as far away, it receives only a quarter the light) which is a serious hurdle for indoor growers, and many techniques are employed to use light as efficiently as possible. Reflectors are thus often used in the lights to maximize light efficiency. Plants or lights are moved as close together as possible so that they receive equal lighting and that all light coming from the lights falls on the plants rather than on the surrounding area. Therefore, high Intensity Discharge (HID) lights are often used.

Common types of HID grow-lights for outdoor or greenhouse use include fluorescent grow-lights, Metal Halide (MH) grow-lights, Ceramic Metal Halide (CMH) grow-lights, High Pressure Sodium (HPS) grow-light and Combination MH and HPS (“Dual arc”) grow-lights. Because of the improved effectiveness, energy costs and longevity, many grow-light systems now utilize LED technology. LED grow-lights are composed of light-emitting diodes, usually in a casing with a heat sink and built-in fans. LED grow-lights are designed to emit similar amounts of red and blue light with the added green light to appear white. White LED grow-lights provide a full spectrum of red, blue and green light designed to mimic natural light in the 400 to 700 nanometer wavelength range.

PAR and Photo-synthetically Active Radiation (PAR) is the total amount of light available for photosynthesis within a given system, including both artificial and natural sources of light. In an outdoor or greenhouse structure where natural light is available, PAR varies by the time day, as well as seasonally with the latitude of the sun. An indoor grow environment without natural light, such as a warehouse or modular growing container, relies on artificial light to produce total PAR.

A controller to the LED Grow-light System and is often combined to simulate specific growing conditions, such as increasing PAR in the winter.

### SUMMARY OF INVENTION

One shortcoming of currently available LED grow-light systems is a rapid die-off in light density, and/or light intensity, from the central portion of an LED light canopy towards the outer edges of the LED light canopy. One solution would be to make a LED grow-light canopy that is substantially larger that the grow bed being illuminated by the LED grow-light canopy. This solution however is not satisfactory because of the increased footprint and inefficient energy consumption of the grow-light system. Currently available LED grow-light systems, are also not well suited for providing vertical light canopies for vertical grow beds. Furthermore, the LED grow-light canopy generally needs to be manually raised or lowered to accommodate the growth of plants or change lighting intensity above the grow bed within a central illumination area.

Another shortcoming of LED grow-light systems, is the excess heat generated be lighting equipment, which amplifies systemic imbalances such as humidity. Farming containers without adequate space for large ventilation systems can reduce light source density, either physically or in intensity, and/or reduce plant density. However, the subsequent effect is sub-optimal PAR and an overall reduction in farm productivity.

The present invention is directed to LED Grow-light System comprised of a grow-light canopy, which is comprised of a number of LED light bars that are preferably elongated linear LED light bars, arranged in parallel, on a canopy support structure. Each of the LED light bars include LEDs or arrays of LED arranged along a light emitting surface. The light emitting surfaces of the linear LED light bars, collectively illuminate a grow area that is below the grow-light canopy.

The LEDs utilized in the LED light bars of the present invention can include LEDs emitting light having any number of wavelengths/colors or combinations of wavelengths/colors suitable for the application at hand. The LED's utilized in the linear LED light bars can be tunable to change light emitting profiles and can also be dimmed to change the intensity of light emitted from individual LED light bars or collectively from all of the LED light bars.

In accordance with an embodiment of the invention, individual grow-light canopies, and linear LED light bars, or a portion thereof, are configured to move up and down relative to the grow-light bed. The linear LED light bars, or the portion of the light bars that are configured to move up or down manually and/or automatically, respond to control commands from controller module in response to feedback from the grow-light sensors. The positions of the linear LED light bars relative to the grow bed can be controlled from a wireless control or a remote computer to execute grow-light protocols or programs. The positions of the linear LED light bars relative to the grow area, are preferably adjusted through stepper motors attached to the LED grow-light canopy that move up and down along canopy structures of the LED grow-light system.

In accordance with the preferred embodiment of the invention, a conventional skylights and/or short cylinders coated in highly reflective material, also known as a light tube, is installed into the roof surface or side structure of a growing container. The light tube, in a straight or bent configuration, redirects sunlight from a collecting dome on the exterior of a container to a light emitting diffuser inside the container to supplement artificial lighting within any configuration of containers with very little loss in efficiency and minimal added heat transfer. Sensors monitor existing light availability, providing feedback for a central controller to control the function of the LED grow-light system to optimize PAR.

Skylights and optical tube of the present invention can also be used in warehouses, buildings dn other enclosures alone or in combination with the grow-light canopy systems described herein

### BRIEF DESCRIPTION OF THE DRAWINGS

FIG. 1A shows a schematic representation of grow-light canopy with linear LED light bars.

FIG. 1B illustrates a linear LED light bar with spatially modulated LEDs or arrays of LEDs located along a light emitting surface of the linear LED light bar, in accordance with the embodiments of the invention.

FIG. 1C illustrates a linear LED light bar with physically modulated LEDs or arrays of LEDs located along a light emitting surface of the linear LED light bar, in accordance with the embodiments of the invention.

FIG. 1D shows a schematic representation of light density emitted from a light emitting surface of modulated linear LED light bars

FIG. 1E shows a schematic representation of grow-light canopy with linear LED light bars that are modulated via parallel separation, in accordance with the embodiments of the invention.

FIGS. 2A-B shows a schematic representation of LED grow-light systems with linear LED light bars that move up and down relative to the grow-light bed, in accordance with the embodiments of the invention.

FIGS. 3A-B shows a graphical representation of evenly distributed light density over the grow-light bed afforded from the LED grow-light system of the present invention as well as for prior art LED grow-light systems, respectively.

FIGS. 4A-B illustrate a LED grow-light system with a LED grow-light canopy that moves up and down relative to a grow bed through the use of stepper motors attached to the LED grow-light canopy which moves up and down along support pole structure, in accordance with the embodiments of the invention.

FIG. 5A shows a schematic representation of a control of a module, which controls positioning of a LED grow-light canopy relative to a grow bed, and implements a grow-light protocol or program, in accordance with the embodiments of the invention.

FIG. 5B illustrates a LED grow-light system with a control module, sensors, and a movable LED grow-light canopy, in accordance with the embodiments of the invention.

FIGS. 6A-B illustrates a series of skylights installed a modular grow container, in accordance with the embodiments of the invention.

FIGS. 6C-D illustrates light tubes on the wall plane of a modular grow container, in accordance with the embodiments of the invention.

FIG. 7A illustrates two modular grow container in a stacked configuration, with skylights installed on the roof surface, and light tubes with a bent design installed on the wall plane of a modular growing container.

FIG. 7B illustrates a cross section of a modular grow container in a stacked configuration with LED Grow-light canopies inside.

### DETAILED DESCRIPTION OF THE INVENTION

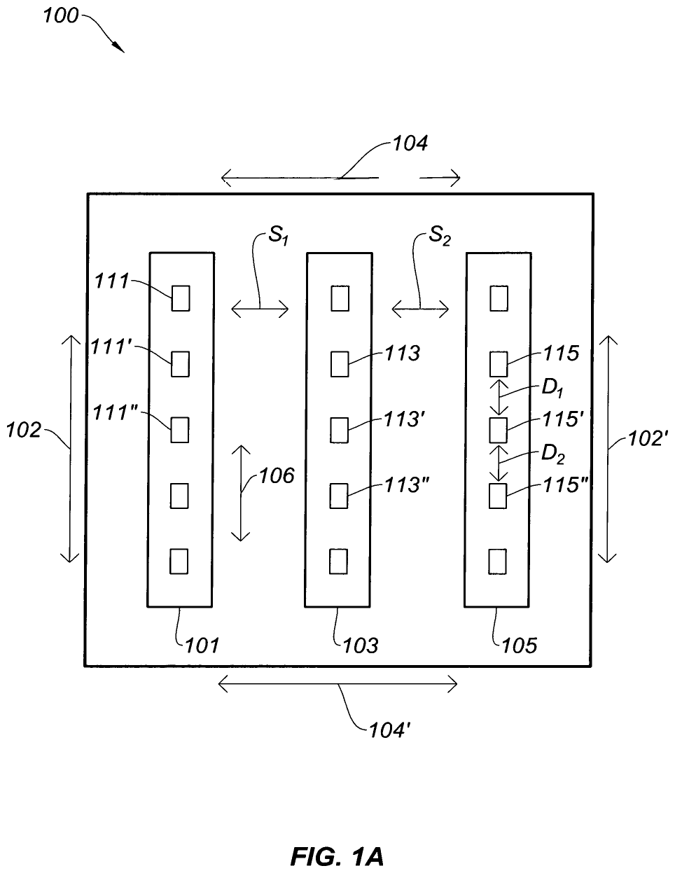

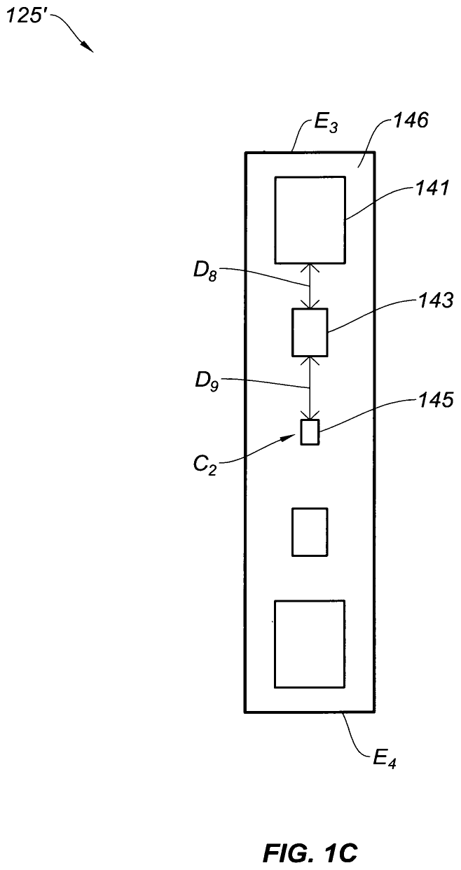

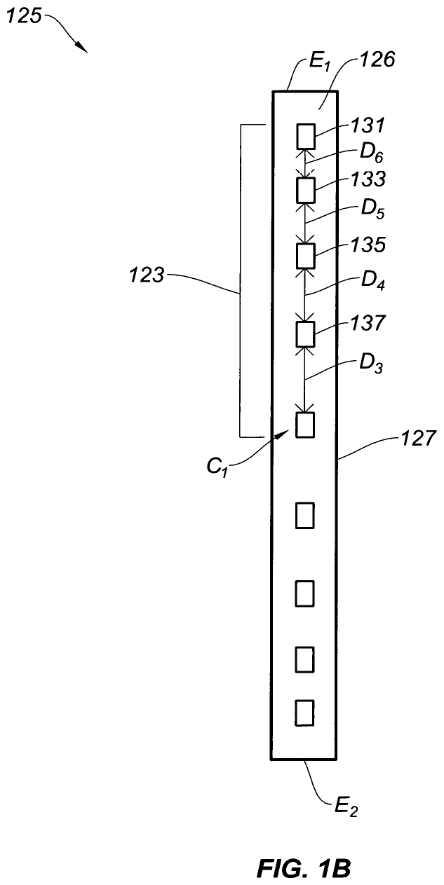

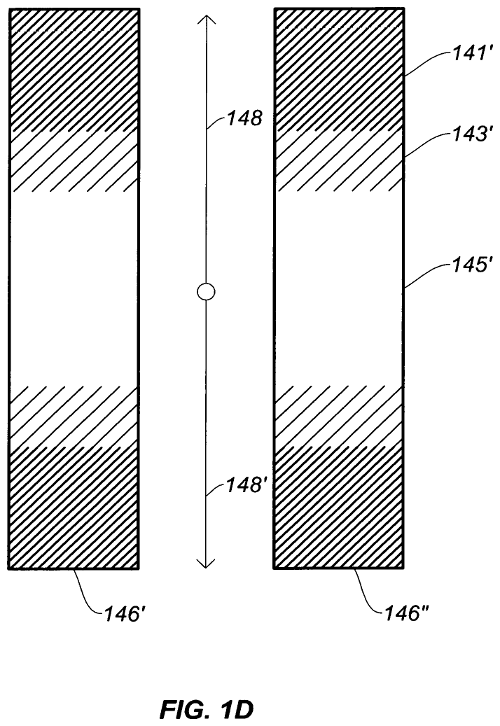

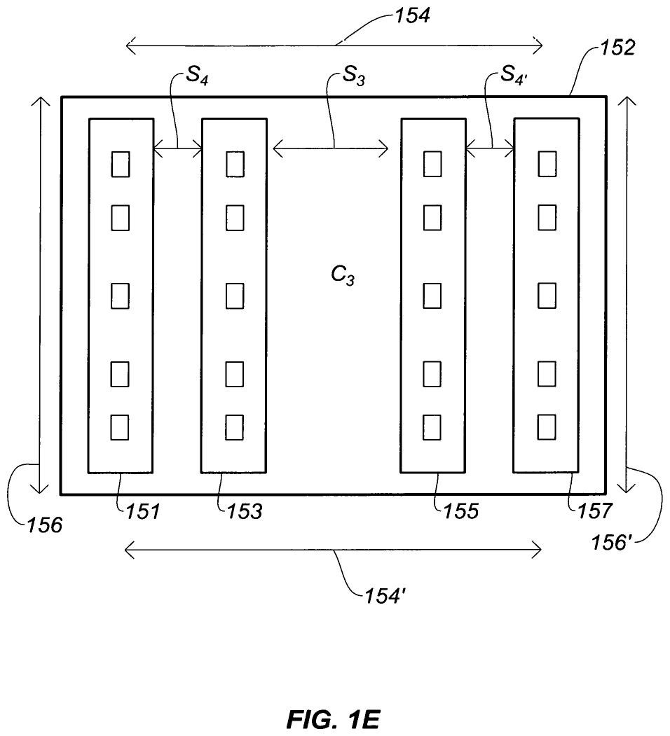

Referring to FIG. 1A, a LED grow-light system can includes a LED grow-light canopy 100 with any number of LED light bars 101, 103 and 105. The LED light bars 101, 103 and 105 are preferably linear elongated LED light bars that are arranged with respect to each other in a parallel or elongated direction, as indicated by the arrow 106.

Each of the LED light bars 101, 103 and 105 includes LEDs or arrays of LEDs 111/111′/111″, 113/113′/113″ and 115/115′/115″, respectively. The separation between adjacent and sequential LEDs or arrays of LEDs 111/111′/111″, 113/113′/113″, and 115/115′/115″ is uniform, as indicated by the arrow D₁ and D₂. Also, the parallel separations of distances between adjacent LED light bars is also usually uniform, as indicated by the arrow S₁ and S₂. The light canopy 100 described and illustrated in FIG. 1A will exhibit die-off in light density and/or intensity around the outside edges 102/102′ and 104/104′ of the LED grow-light canopy 100 and around edges of any grow bed of comparable size positioned below the LED grow-light canopy 100.

FIG. 1B illustrates a linear LED light bar 125 with spatially modulated LEDs or arrays of LEDs 131, 133, 115 and 137 that are located along a light emitting surface 126 of the linear LED light bar 127. The spatially modulated LEDs or arrays of LEDs 131, 133, 135 and 137 are arranged such that distances D₃, D₄, D₅ and D₆ between adjacent LEDs are sequentially reduced from the center of portions C₁ of the light emitting surface 126 to the two end portions E₁ and E₂ of the light emitting surfaces 126 or LED light bar.

Using light bars with the spatially modulated LEDs or arrays of LEDs 131, 133, 135 and 137 to compose a LED grow-light canopy, increases light density and/or light intensity emitted around edges of the LED grow-light while keeping the LED grow-light canopy footprint sized to match a grow bed of the same or similar size. In further embodiments, groups of LEDs, or modulated arrays of LED's 123 can be grouped to form LED arrays of various sizes.

FIG. 1C. illustrates a linear LED light bar 125′ with physically modulated LEDs or arrays of LEDs or grouping of LEDs 141, 143 and 145, located along a light emitting surface 146 of the linear LED light bar 125′. In accordance with this embodiment of the invention the from factor or size of the LEDs, or arrays of LEDs, or grouping of LEDs, are larger near end regions E₃ and E₄ than the center region C₂. The LED groupings 141, 143 and 145 are arranged such that distances D₈ and D₉ between adjacent LEDs are sequentially reduced from the center portions C₂ of the light emitting surface 146 to the two end portions E₃ and E₄ of the light emitting surfaces 146 on the LED light bar 125′.

Referring now to FIG. 1D, where LED light bars have spatially modulated LEDs, and/or arrays of LEDs, such as described with reference to FIG. 1B, and/or physically modulated or sized arrays of LEDs, such as described with respect to FIG. 1D. Preferably, The LED light bars 146′ and 146″ used to form a grow-light canopy of the present invention exhibit a gradient distribution of lighting, as indicated by the shading 141′ 143′ and 145′, as well as in the linear or elongated directions, as indicated by the arrows 148 and 148′. The gradient distribution of light, as indicated by the shading 141′ 143′ and 145′, and exhibited by the LED light bars 146′ 146″ in the directions 148 and 148′ preferably corresponds to an increase of light density or light intensity (luminous flux and luminous intensity) of 5% to 25% or more as measured from the central portions of the linear LED light bars 146′ and 146″ to each end portion of the LED light bars 146′ and 146″.

Referring to FIG. 1E, while modulated linear LED light bars 151, 153, 155 and 157, described above with respect to FIGS. 1B-C, reduces die-off of in light density and/or light intensity at/or near end edges 154 and 154′ of a grow box positioned under or below a LED grow-light canopy 152 formed from modulated linear LED light bars, the parallel edges 156 and 156′ of the grow box can still experience die-off of light density and/or light intensity. In order to address the die-off in light density and/or light intensity distribution near the parallel or outer edges of the grow box, the parallel separation or distances S3, S2, S3′ between adjacent linear LED light bars are modulated such that the separation or distances S3, S2, S3′ decrease from the center portions C₃ of the LED grow-light canopy to outer side portions of parallel edges 156 and 156′ of the LED grow-light canopy 152.

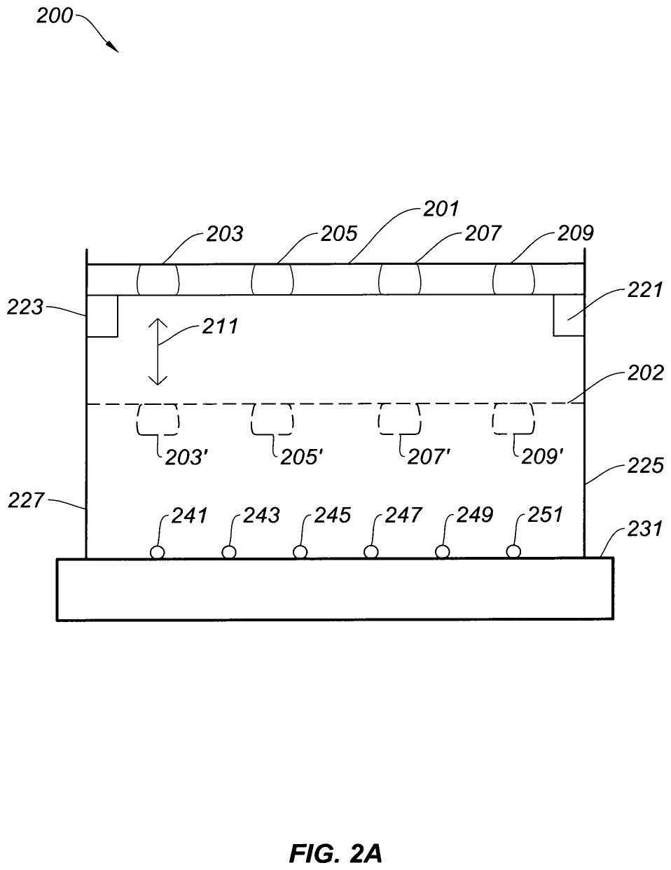

FIG. 2A shows schematic representation of LED grow-light systems 200. The LED grow-light system 200 includes a grow-light canopy 201. The grow-light canopy includes linear LED light bars 203, 205, 207 and 209. The LED light bars 203, 205, 207 and 209 can include LEDs, modulated and/or in arrays, that are spatially modulated with respect to each other laterality on the grow-light canopy 201, such as described above with reference to FIG. 1E.

Preferably the grow-light canopy 201 and/or the LED light bars 203, 205, 207 and 209 move up and down, as indicated by the arrow 211. In a lowered position 202, the LED light bars 203′, 205′, 207′ and 209′ can emit greater intensity of light on to the grow bed 213. Preferably, the light canopy 201 and/or the LED light bars 203, 205, 207 and 209 move up and down by stepper motors 221 and 223 that are attached to vertical pole structures 225 and 227, which support the grow-light canopy 201 over the grow bed 231. Still referring to FIG. 2A, the LED grow system 200 also includes sensors 241, 243, 245, 247, 249 and 251 for providing environmental data. The sensors 241, 243, 245, 247, 249 and 251 can include, but are not limited to light sensor, moisture sensor, temperature sensor, etc. The environmental data generated by the sensor can be used to determine a desired or preferred position of the light canopy 201 relative to the grow bed 231 and/or can be used to implement an automated grow-light protocol or program suitable for the vegetation being cultivated.

Referring to FIG. 2B, in an alternative embedment of the invention, a LED grow-light system 200′ includes a grow-light canopy 201′ with LED light bars 203′, 205′, 207′ and 209′ wherein a portion of the LED light bars 203″ and 209″ move up and down, as indicated by the arrow 211′ to the lowered position 202′ with lowered LED light bars 203″ and 209″. In this way, the relative heights of LED light bars 203′, 205′, 207′ and 209′ can be modulated relative to the grow bed 231′. As mentioned, the LED grow system 200′ can include any number of sensors 241′, 243′, 245′, 247′, 249′ and 251′, which are used to instruct and control positioning of the LED light bars 203′, 205′, 207′ and 209′ relative to the grow bed 231, and/or used to implement an automated grow-light protocol or program suitable for the vegetation being cultivated.

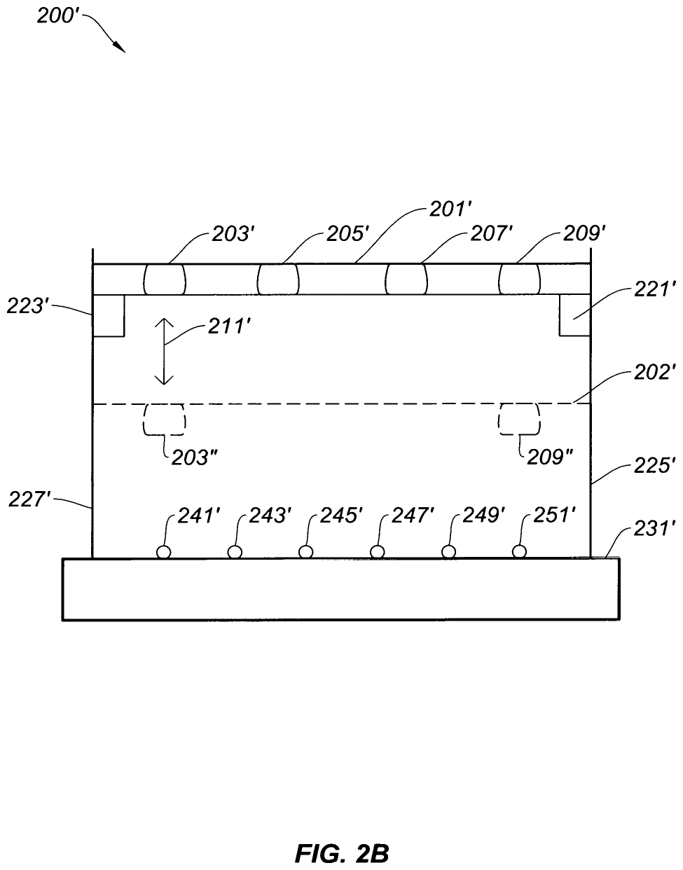

FIG. 3A shows a graphical representation 301 of an evenly distributed light density, or light intensity 311, over the area of a grow-light bed. The axis 315 corresponds to light density, or light intensity, at/or near end edges 154/154′ (FIG. 1E) of a grow box 231/231′ (similar to FIG. 2A-2B) positioned under, or below, a LED grow-light canopy 152 (FIG. 1E) formed from modulated linear LED light bars. Axis 313 corresponds to parallel edges 156/156′ (FIG. 1E) of a grow box 231/231′ (similar to FIG. 2A-2B) positioned under, or below, a LED grow-light canopy 152 (FIG. 1E) formed from modulated linear LED light bars.

FIG. 3B shows a graphical representation 351 of an unevenly distributed light density and/or light intensity 361 over the area of a grow-light bed. The axis 365 corresponds to light density, or light intensity, at/or near end edges 154/154′ (FIG. 1E) of a grow box 231/231′ (similar to FIG. 2A-2B) positioned under, or below, a LED grow-light canopy 152 (FIG. 1E) formed from unmodulated linear LED light bars. Axis 363 corresponds to parallel edges 156/156′ (FIG. 1E) of a grow box 231/231′ (similar to FIG. 2A-2B) positioned under or below a LED grow-light canopy 152 (FIG. 1E) formed from unmodulated linear LED light bars.

Comparing FIG. 3A and FIG. 3B, the light density, and light intensity, near end edges 154/154′ (FIG. 1E) of a grow box 231/231′ (similar to FIG. 2A-2B) positioned under or below a LED grow-light canopy 152 (FIG. 1E) is more evenly distributed with modulated linear LED light bars than with unmodulated LED light bars.

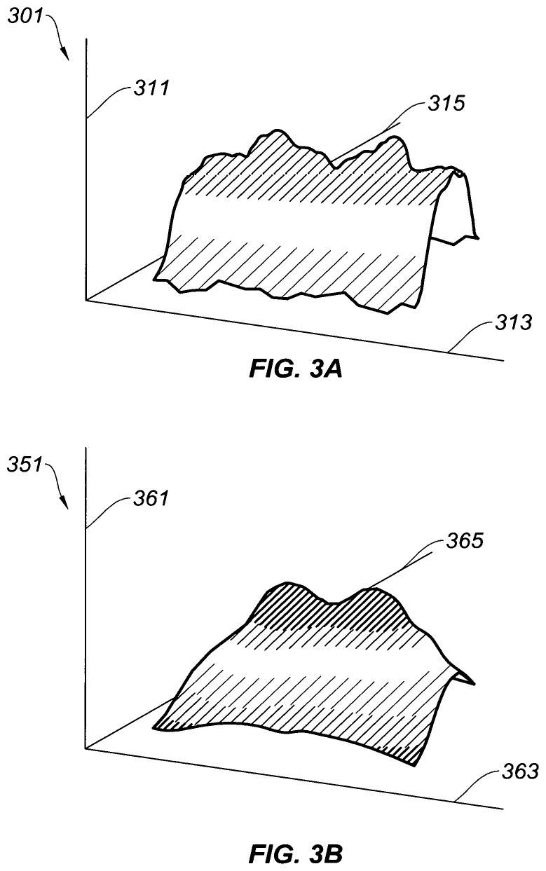

Referring to FIGS. 4A-B, a LED grow-light system 400 includes a grow-light canopy 411 with any number of LED light bars 411 that can be moved up and down relative to a grow bed 403. The grow-light system 400 has a support structure 401 that includes vertical poles. The grow-light canopy 411 preferably moves up and down relative to the grow bed 401 using stepper motors 421, 423 and 425 that are attached to the grow-light canopy 411 that moves up and down along the vertical poles 431, 433, and 435. In accordance with the embodiments of the invention, the grow-light canopy 411 will automatically move up to accommodate growth of vegetation 405, 405′ and 405″ being cultivated.

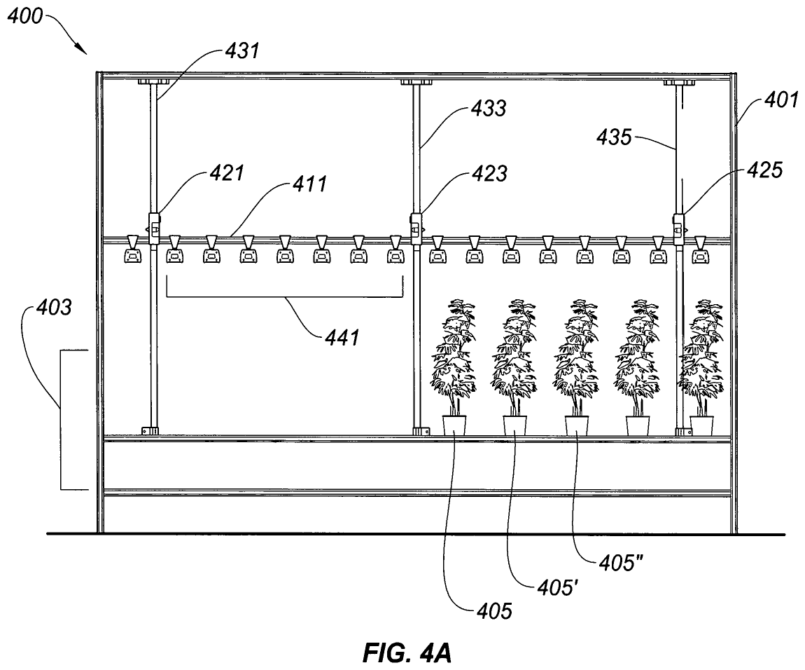

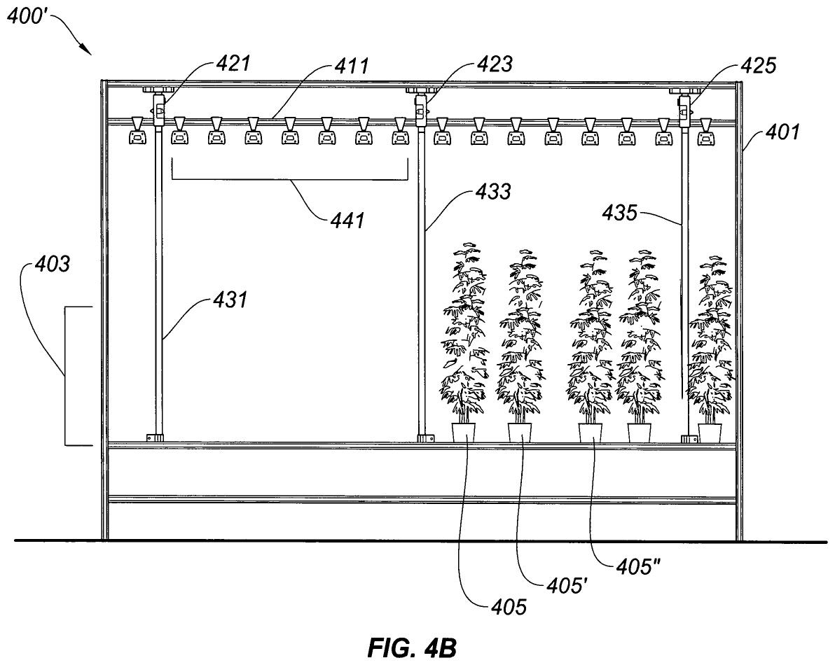

FIG. 5A shows a schematic representation of control module 501, which controls the positioning of a LED grow-light canopy 510, with linear LED light bars 509 and 511, relative to a grow bed (not shown) and implementing grow-light protocols or programs. The control module 501 includes a micro-processor with memory 507 for storing data and running grow-light protocols or programs. The control module is coupled to sensor 515, to receive environmental data, and a radio receiver 508, to receive input instructions 516. In operation, an output interface 503 instructs stepper motors 505 to move the LED grow-light canopy 510 in accordance with grow-light protocols or programs, and input instructions 516 received by the radio receiver 508 and the environmental data provided by the sensors 515.

FIG. 5B illustrates a LED grow-light system 525 in accordance with the embodiments of the invention. The LED grow-light system 525 includes a support structure 511 for supporting a grow-light canopy 531 over a grow bed 529 with plants 561 and 563 thereon. The grow-light canopy 531 includes linear LED light bars 541, 543, 545 and 547 that are configured to go up and down along a portion of the support structure 511, as indicated by the arrow 533 via stepper motors 521, 523, 527, or any other suitable mechanism including, but not limited to, chain, pulley, and wheel-type mechanisms. The LED grow-light system 525 can also include a number of environmental sensors 513, 515, 517 and 519 for detecting lighting conditions, temperature conditions and/or moisture conditions. The environmental sensors 513, 515, 517 and 519 are preferably in communication with a control module 501′, either directly or through a wireless network 555, to provide feedback of growing conditions which are then used to modify the operational parameters of the LED grow-light system 525. The control module 501′ includes all of the necessary components to control the position of the grow-light canopy 531 relative to the grow bed 529 and or the plants 561 and 563 thereon, as well as operation of lighting conditions (illumination times/intensities/colors) provides by the grow-light canopy 531.

The control module can include an antenna structure 502 for receiving remote control commands 555 from a wireless remote control device 553, such as a cell phone, and/or by receiving input data or command instructions over a network via a networked remote computer 551 to run a grow-light protocols and programs, or execute the command instructions. In yet further embodiments of the invention, the LED grow-light system 525, or the grow-light canopy 531 includes additional motors or mechanisms 537 and 539 for controlling or modulating the lateral spacing in the direction indicated by the arrow 540 of adjacent linear LED light bars on the grow-light canopy 531.

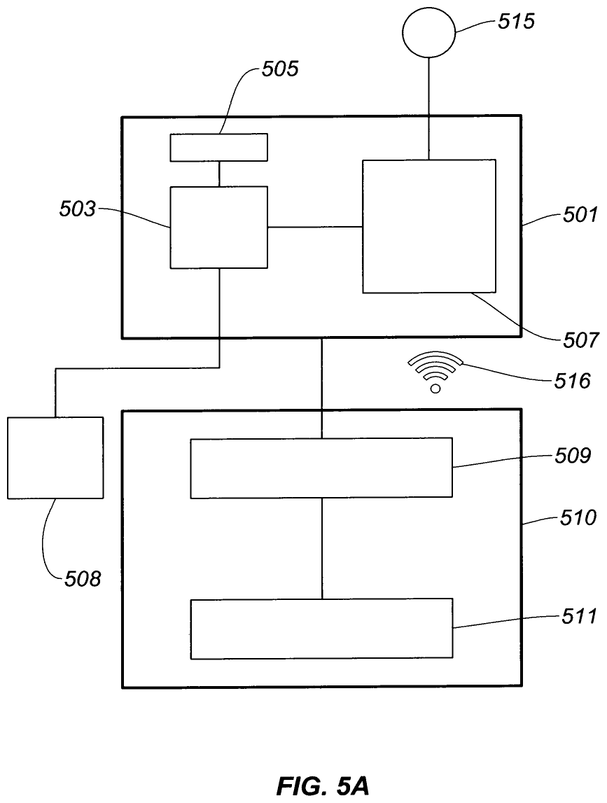

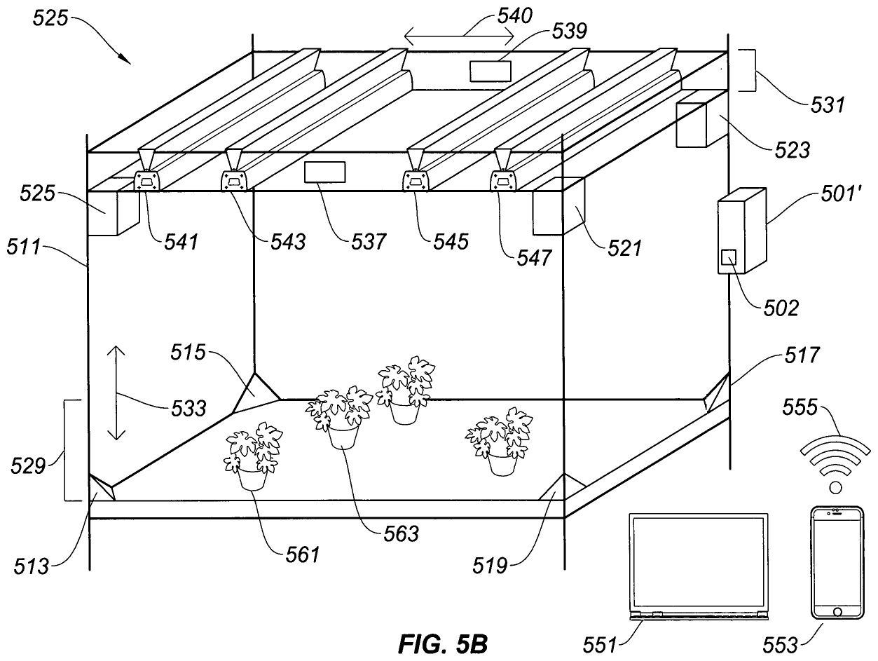

FIGS. 6A-6B illustrate a LED grow-light system 600 with a grow container 605 and panel skylights 601, 602, 603, and 604 installed on the roof or top surface.

Referring to FIGS. 6C-6D, the grow-light system 610 is illustrated with single grow container 613 showing light tubes 612 and 613 installed on the wall surface of the grow container. The light tubes can be bent or bendable and can include lens covers, wave guides and/or have reflective interior surfaces to help direct light into the grow container 613.

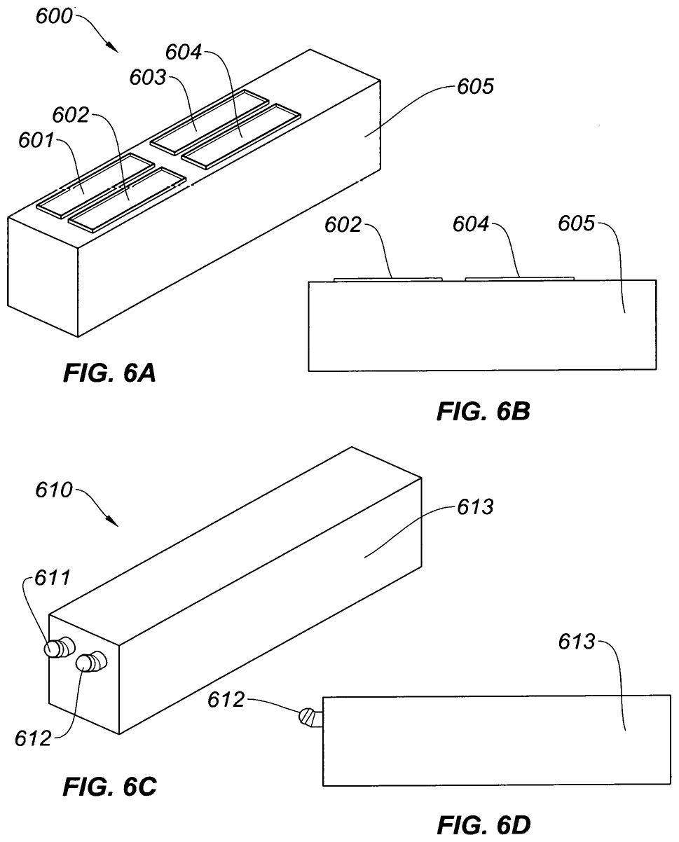

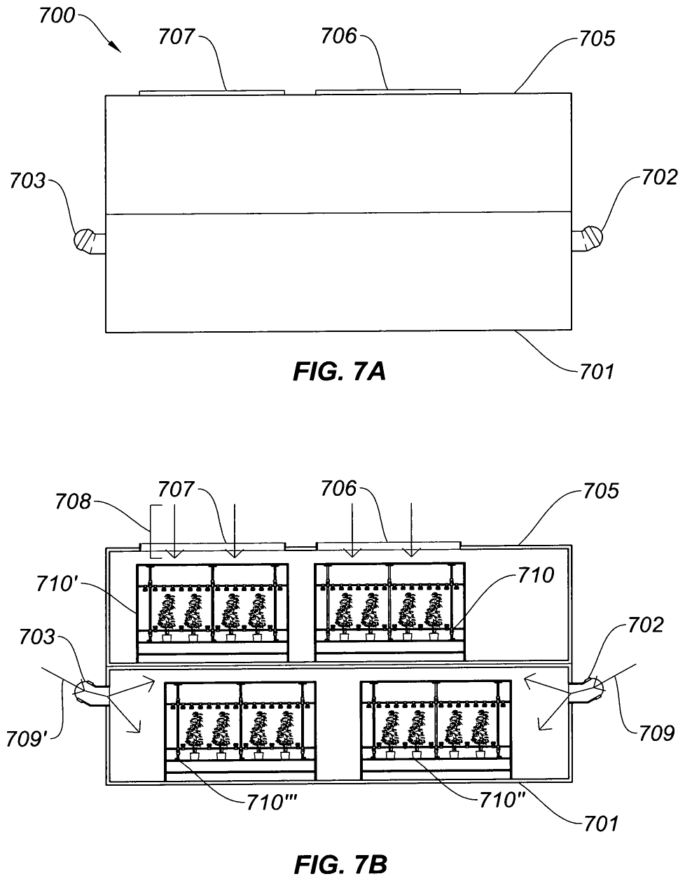

FIGS. 7A-B illustrates the LED grow-light system 700 configured with two stacked modular growing containers 701 and 705 in accordance with the embodiments of the invention. The grow container 701 has bend light tubes on side walls, such as described above with reference to FIGS. 6C-D. The grow container 705 includes panel skylight features 706 and 707 installed on top surfaces, such as those described above with reference to FIGS. 6A-B. Using combinations of sky light configurations allows multiple modular grow containers to be stacked and/or placed next to each other while allowing light to enter into each of the modular grow containers, as indicated by the arrows 708, 709 and 709′.

The grow light system 700 of the present invention can include any number of grow light canopy systems 710, 710′, 710″ and 710′″ housed within the modular grow containers 701 and 705, as shown. Details of the grow light canopy systems 710, 710′, 710″ and 710′″ are described above with reference to FIGS. 4A-B and FIGS. 5A-B.

The present invention has been described in terms of specific embodiments, incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A LED grow-light system comprising:
a) a top light canopy with top linear LED light bars for providing downward lighting into a open central illumination area, the top LED light bars being parallel with respect to each other;
b) a bottom light canopy with bottom linear LED light bars for providing upward lighting into the open central illumination area, the bottom LED light bars being parallel with respect to each other, and wherein the top light canopy or bottom light canopy move up and down along vertical poles to change distances between the top light canopy and the bottom light canopy to thereby modulate the open central illumination area;
c) a containment module that houses the top light canopy and the bottom light canopy, the containment module having one or more skylights or optical tubes for providing natural light into the open central illumination area.
